(19) United States
(12) Patent Application Publication
(10) Pub. No.: US 2017/0132287 A1
(43) Pub. Date: May 11, 2017

(54) SYSTEMS AND METHODS FOR ORGANIZING AND DISTRIBUTING DIGITAL INFORMATION

(71) Applicant: Ehkko, LLC, Panama City, FL (US)

(72) Inventor: Jim Greiff, Panama City, FL (US)

(21) Appl. No.: 15/344,574

(22) Filed: Nov. 6, 2016

Related U.S. Application Data
(60) Provisional application No. 62/251,761, filed on Nov. 6, 2015.

(51) Int. Cl. G06F 17/30

(52) U.S. Cl. CPC G06F 17/30525; G06F 17/30371

(57) ABSTRACT

Systems and methods presented herein allow for organizing and distributing digital information. Through a user interface, the system allows a user to define containers corresponding to a portion of digital information stored on a storage device. The user can also assign one or more contacts to that container, as well as define a trigger event for the container. When the trigger event is detected, the system can provide the one or more contacts with access to the container.

### DESCRIPTION OF THE EMBODIMENTS

### Field of the Embodiments

The embodiments herein relate generally to systems and methods for organizing and distributing digital information, and, more specifically, to systems and methods for organizing and automatically distributing digital information according to user-defined trigger events.

### BACKGROUND

While the continued digitalization of the modern world provides many advantages such as efficiency, mobility, and accessibility, it also poses unique challenges. One major challenge involves categorizing and distributing information to the desired individual(s) in an efficient and seamless manner.

In the past, a person would likely collect physical files or objects over time (e.g., photographs, letters, video tapes, business documents). Sharing or transferring those files involved simply sending the physical objects to someone else. But today, most of that information is digital. While there are many ways to transfer digital files (e.g., email, file-sharing programs), none of them efficiently share data across multiple platforms and multiple users in an automatic and seamless manner. Each time a user wants to send information, they must prepare and email and send it.

Existing systems do not efficiently share data in instances where the original user is unavailable. For example, when a person passes away, distributing their digital photo collection to a group of family members is not a simple task. A family member would need to obtain access to the user's computer, search the computer for the photos, and determine a method of transferring the data to themselves and the others in the family. This result is not ideal, as the user may not wish to grant full access to their computer for the simple task of distributing photos.

Therefore, a need exists for systems and methods for organizing and distributing digital information, and, more specifically, to systems and methods for organizing and automatically distributing digital information according to user-defined trigger events.

### SUMMARY

Embodiments described herein include systems for organizing and distributing digital information. In one embodiment, the system includes at least a storage device, a user interface, and a processor. The storage device stores digital information and is operatively connected to the user interface. The processor is in communication with both the storage device and the user interface. The processor may be configured to execute various instructions related to the storage device and/or user interface. For example, the processor may establish a user-defined container corresponding to a portion of the digital information stored on the storage device. It may also establish a user-defined trigger event for the container. The processor can also assign a first contact to the container, the first contact being provided access to the container based on the trigger event. The processor can detect the trigger event and execute instructions in response to detecting the trigger event.

New content items may be added to an established container based on user input, without the need to reassign contacts to that new content item. Additionally, a plurality of user-defined containers may be established. In one embodiment, the first contact is provided access via at least one of sending the digital information to the first contact, providing a password for the first contact to download the digital information, or storing the digital information in a first-contact storage location.

The trigger event may be detected by the processor via entry of an authorized trigger key. For example, the trigger key may be a password provided by an administrator of a user's estate, perhaps provided to the administrator through the user's will. The trigger event may also be a date and time, a target stock price, or other external variable. In one example, the authoring user (e.g., container creator) designates another one or more users as triggering users who are authorized to trigger the event.

In one example, the user can designate an administrator user for a death trigger. The system can email the administrator at a scheduled date to ask the administrator if the user is still alive. In one example, this occurs at higher frequency as the user advances in age. This can allow the administrator to periodically verify that the user is still alive. Alternatively, the administrator can indicate that the user is deceased, which can act as an event trigger.

The user interface can include a contact list. A user can assign any number of contacts in the contact list to a particular container. The trigger event provides access to a container to any contacts assigned to that container. Additionally or in the alternative, the trigger event may provide full access to the user interface itself so that the assigned contact(s) can interact with the full user interface and revise assigned contacts, containers, and so on.

In another example, a non-transitory, computer-readable storage medium is provided including instructions that, when executed by a processor of a computing device, cause the processor to perform stages for organizing and distributing data. For example, the processor can establish a container based on a user's request. The processor can associate data with the container, such as associating a digital document with the container. A first contact can be assigned to the container. The user can define a trigger event for the container, and the processor can monitor for that user-defined trigger event. In response to detecting the trigger event, the processor can provide the first contact with access to the container.

In one example, the processor of the computing device can add new content items to the container based on user input. For example, the user can select a file, using a graphical user interface (“GUI”), and drag the file into the container. The user can also establish trigger events using the GUI. In one example, the trigger can include receiving a passkey at the GUI. In another example, the trigger can include a date and/or time. In yet another example, the trigger can include a time period of non-responsiveness from the user, such as one week.

The designated contact for a container can receive access in a variety of ways. In one example, the first contact is provided access by sending the data associated with the container to the contact, such as in an email or other digital message. In another example, the contact is provided with a login by which the contact can view or download the data associated with the container.

Both the foregoing general description and the following detailed description are exemplary and explanatory only and are not intended to restrict the scope of the invention as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an illustration of an example embodiment of a user interface for organizing and distributing digital information;

FIG. 2 is a flowchart depicting an example embodiment of a system for organizing and distributing digital information; and

FIG. 3 is an exemplary illustration of example hardware components utilized in a system for organizing and distributing digital information.

### DETAILED DESCRIPTION

Reference will now be made in detail to the present exemplary embodiments, including examples illustrated in the accompanying drawings. Wherever possible, the same reference numbers will be used throughout the drawings to refer to the same or like parts.

Exemplary embodiments herein allow a user to organize and distribute digital information in accordance with a defined trigger event. In one embodiment, the system includes a storage device, a user interface operatively connected to the storage device, and a processor in communication with the storage device and the user interface.

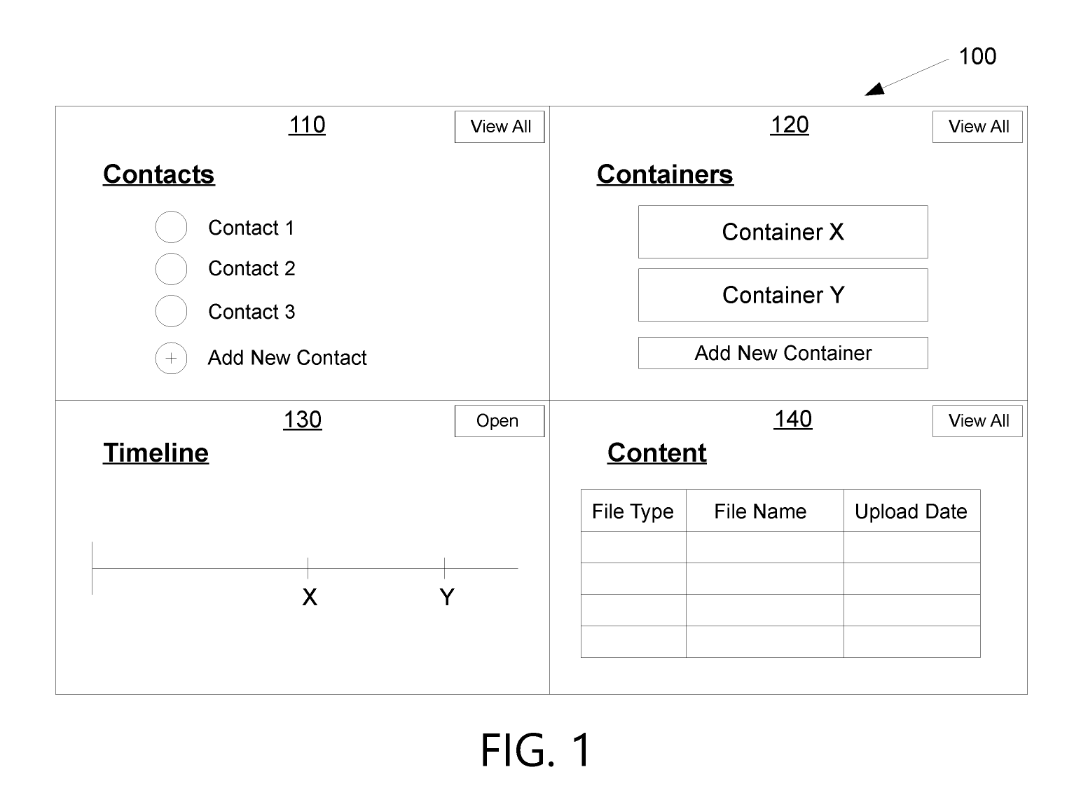

An exemplary user interface 100 is depicted in FIG. 1. While the user interface 100 may be customized in a variety of ways, this particular embodiment shows four windows displayed within the user interface 100. More particularly, the user interface 100 includes a Contacts window 110, Containers window 120, Timeline window 130, and Content window 140. The user may have the ability to rearrange these windows or replace them with additional or alternative windows. For example, an integrated Email window may be used. Alternatively, the windows may show a more detailed view of the windows shown in FIG. 1. For example, when the user opens a particular container, such as Container X, the Containers window 120 may be replaced by a Container X window, which may depict the contents of Container X and other details associated with that container.

Turning to the Contacts window 110 in more detail, it can be seen that this window may function as a collection of the user's contacts. In this embodiment, three contacts are shown, along with a button to add more. The user may configure the Contacts window 110 to show more, or fewer, contacts as desired. Additionally, the user may click on the “View All” button within the Contacts window to see all of their contacts. For each contact, the user can input various types of information, such as: name, address, email address(es), phone number(s), relation, and so on. Additionally, the user may choose a preferred method of potential access to the contact. For example, the user may wish to potentially allow access to one user via a direct email while allowing access to another user by provision of a password that gives access to a server, contact storage location, or shared folder.

The Containers window 120 shows a list of the user's containers. In this example, the user has already created Container X and Container Y. There is also an “Add New Container” button that allows the user to create a new container. For each container, the user is able to define various parameters and determine the contents of the container. For example, the user may place a birthday video file (e.g., a .mpg file) within Container X. This action can be carried out by simply dragging and dropping a file located in the Content window 140 up to the Container X button within the Container window 120. The user may also associate a container with particular users. Continuing the example above, the user may wish to deliver the birthday video file to Contact 2 on their 18th birthday. To assign a contact (e.g., recipient) to a container, the user can simply drag the Contact 2 icon to the Container X button. The user may be prompted at that point to provide additional details about the container, or may open the container to a more detailed view to provide those additional details.

For example, the user may set a particular trigger event upon which access to the container is granted to the contact. Trigger events may take a variety of forms and are discussed in more detail below. In the example embodiment described above, the user might choose the date of Contact 2's 18th birthday as the trigger event. This selection may be accomplished by opening a detailed view of Container X, which provides for the selection of various trigger events and other details. The user may also choose the form in which the contact is provided access. For example, the user can determine that when the trigger event (in this example, the date of Contact 2's 18th birthday) occurs, the system will automatically: email the video file to Contact 2, post the video file on a social media account associated with Contact 2, send Contact 2 information regarding how to download the video from a server, send Contact 2 a URL address for a site hosting the video, or any other available method of allowing access.

Although in the example above only one file and one contact is discussed, in both instances multiples may be involved. That is, each container may contain multiple different files or other digital information, and similarly each container may be associated with multiple different contacts. Furthermore, the different contacts associated with a container may be provided different levels of access or may be associated with different trigger events. For example, say a parent wishes to share family documents with two children, but only when each child is 21 years old. Assuming the children are different ages, they can each be assigned an individual trigger date upon which the family documents are shared.

While the user may use a particular date and/or time as a trigger event, various other events may define a trigger event. For example, the trigger event may involve the entry of an authorized trigger key. This may be useful in situations where a particular event must be verified by another party. An example use for an authorized trigger key would be in conjunction with the execution of a deceased user's will. In that example, a user may provide an authorized trigger key to a trustee, attorney, or simply include the key in the will itself. The user's will may call for an executor to enter the authorized trigger key through a website or through the disclosed system itself. The authorized trigger key may provide the trigger event for one or more containers, thereby providing the desired contacts with the desired access to information. Requiring an authorized trigger key may be advantageous in situations where the underlying trigger event is difficult to determine by the system without external input.

In another example, a trigger event can include a lack of response from the user within a predetermined time period. For example, the system can prompt the user to enter credentials once a month. The prompt can take any form, such as an email, SMS, MMS, electronic message, or phone call. The prompt can request that the user either respond directly (with a return SMS message, for example) or access a website to provide the requested credentials. If the user does not enter the requested credentials within 24 hours, the system can send another prompt. If the user does not respond within a predetermined period of time, such as a week, the trigger event is triggered and any designated contacts receive access to the relevant container.

Other types of trigger events may be utilized in addition to, or instead of, the triggers discussed above. In fact, a trigger event may be defined by any external data available to the system. One example is the stock price of a public company. A user may, for example, automatically provide access to a container based on the stock price reaching a predetermined value. This may be useful where the user intends to sell his or her stock at a particular value, but is unable or unwilling to do so manually. In this instance, the user can arrange to automatically send authorization to a stock broker, based on the stock price, requesting that the broker take a particular action such as selling some or all of the user's holdings.

FIG. 1 also shows a Timeline window 130 which may be used to visually track the different trigger events associated with various containers. Logically, the timeline may be most useful for trigger events that are associated with particular dates. In that case the trigger events can be depicted along a timeline in accordance with the dates associated with each trigger event. The depiction may indicate the relevant container associated with the trigger event. In FIG. 1, for example, the timeline shows depictions of Container X and Container Y as “X” and “Y,” respectively. A button, labeled “Open” in the exemplary embodiment of FIG. 1, provides the user with access to a more detailed view of the timeline, and may include additional information about containers that are not associated with date- or time-based trigger events.

Finally, a Content window 140 may be provided to allow a user to easily upload, categorize, and sort various types of digital information. The Content window 140 may include a list of uploaded files, with details regarding the file type, file name, upload date, file size, and other customizable fields. A user may drag a file from a file folder to the Content window 140 in order to upload the file. Once a file is uploaded, the user can drag that file from the Content window 140 to a desired container, thereby placing that file in that container. When a file is place in a container, the user can determine whether to keep the file in the Content window 140 or remove it. The user can also access a more detail view of the Content window 140 by selecting a button, shows in FIG. 1 as a “View All” button.

The system may include features that allow a user to automatically upload content directly into the Content window 140. For example, the user may customize their system such that video/audio recordings from the user's webcam and/or microphone are automatically stored as content files in the Content window 140. Similarly, the user may link certain folders on their computer to the Content window 140, such that simply saving a file in that computer folder causes the file to be uploaded to the Content window 140.

The user can drag additional content items from the Content window 140 into an existing container in the Container window 120. This can allow a user to define a container, having a trigger event and one or more recipients. From that point forward, multiple content types can be dragged into the container. This can save the user valuable time because there is no need to create new recipient or timing information for delivering the new content.

In one example, a plugin can allow the user to send items directly from a camera application on the user device to the Content folder 140. Alternatively, the plugin can allow the user to send a photo directly into a container, such as Container X. A notes plugin can similarly allow a user to easily send notes to the Content window 140 or a container. This can further streamline the content collection process, which can be especially useful when a user is creating a scrapbook or other memory collection for later distribution.

Unlike an email system, an existing container can accept additional content items even though the container is active and scheduled for sending any time the trigger event occurs. In one example, the user need not hit send in order for access to the container to be distributed to recipients.

In one example, when a trigger event occurs, the system determines the cumulative file size of the container contents. If the cumulative file size is over a threshold, such as 10 megabytes, the system will send a link to access the container contents. This can ensure recipients receive access to a container that they might not know exists. In another example, if the system detects an email bounce-back, it can notify another recipient to contact the user of the undeliverable email address. It can also attempt to send a link to the email address instead of attachments, in case the bounce back was related to file size limits.

Exemplary System Flowchart

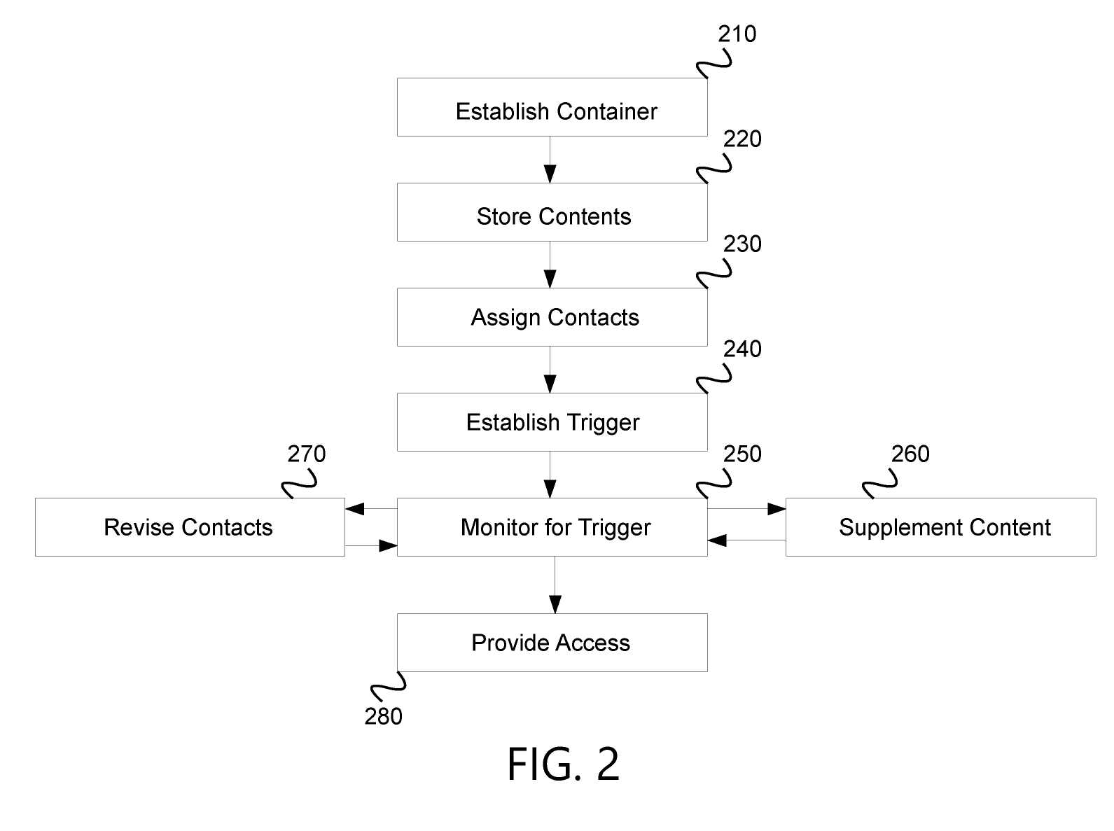

FIG. 2 shows an exemplary system flowchart for an embodiment of the present disclosure. At step 210, the user establishes a container. This may be accomplished via the user interface 100 described above, and more particularly by selecting the “Add New Container” button found in Container window 120 of FIG. 1. This step may include additional sub-steps such as naming the container, organizing the container's display location relative to other preexisting containers, and so on.

After the container has been established, steps 220, 230, and 240 are carried out, but not necessarily in any particular order. The order shown in FIG. 2 is exemplary and may be modified as desired by the user. Using that order as an example, however, the next step 220 is to store contents in the container. As discuss in conjunction with FIG. 1, this may be accomplished by, for example, dragging files uploaded from the Content window 140 to the appropriate container in the Container window 120.

Step 230 involves assigning contacts to the appropriate container. As discussed with respect to FIG. 1, this may be accomplished by, for example, dragging contacts lists in the Contacts window 110 to the appropriate container in the Container window 120. And as mentioned above, step 230 may be carried out before or after step 220, depending on the preference of the user.

At step 240, the user establishes a trigger event for the container of interest. While this step may be carried out before either of steps 220 or 230, in practice it will likely take place after those two steps. In step 240, the user accesses a detailed view of the container view the Container window 120, and selects a type of trigger event. The selection may be chosen from a predetermined list of possible trigger events, such as: date, time, entry of an authorized trigger key, stock price, and so on. The user may select one of these options and then input the particular details associated with each, such as the desired date, time, a code for the trigger key, etc.

After steps 220, 230, and 240 have been completed, the system automatically monitors for the occurrence of a trigger event at step 250. Steps 260 and 270 are optional, but are shown to illustrate the flexibility of the system. Taking step 260 first, a user may supplement content within a container even after setting up all of the parameters of the container through steps 220, 230, and 240, and without having to revisit any of those steps. For example, the user can add additional content to a container by dragging an additional file or files from the Content window 140 to the container in the Container window 120. The new content automatically abides by the previous determinations made at steps 220, 230, and 240—that is, the new content will be made available via the same trigger event established at step 240 and to the most recent set of contacts defined at step 230 (as well as any revisions in step 270). Step 260 may also include removing content from the container.

At step 270, the user can revise the contact list associated with a particular container. For example, the user can add new contacts by dragging new contacts from the Contact window 110 to the relevant container in the Container window 120. Similarly, the user can remove existing contacts from the container without disturbing the settings established in previous steps. Each of steps 260 and 270 may be carried out at any time before the system carries out step 280, without disturbing existing settings associated with the container.

When the system recognizes a trigger event, step 280 is carried out, providing access to the contact(s) associated with the container. Access may be provided in a number of ways, as determined by the user at step 240. For example, access may be provided by electronically sending the contents of the container to the relevant contacts, providing the contacts with a link to download the contents from a web server, providing access to the user interface 100 itself, or any other suitable method.

Exemplary System Hardware Components

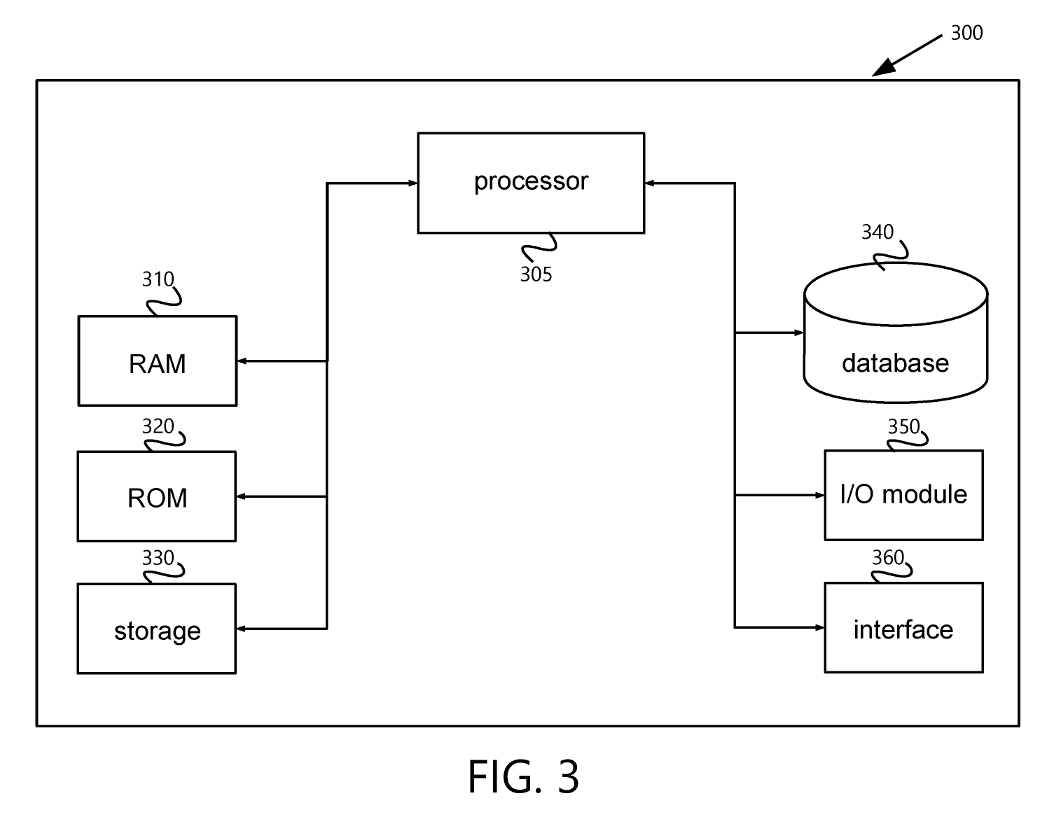

FIG. 3 depicts an exemplary processor-based computing system 300 representative of the type of computing system that may be present in or used in conjunction with the embodiments disclosed herein. Continuing with FIG. 3, the computing system 300 is exemplary only and does not exclude the possibility of another processor- or controller-based system being used in or with one of the aforementioned components. Additionally, content organization and distribution system disclosed herein need not include all the system hardware components in an embodiment.

In one aspect, system 300 may include one or more hardware and/or software components configured to execute software programs, such as software for storing, processing, and analyzing data. For example, system 300 may include one or more hardware components such as, for example, processor 305, a random access memory (RAM) module 310, a read-only memory (ROM) module 320, a storage system 330, a database 340, one or more input/output (I/O) modules 350, and an interface module 360. Alternatively and/or additionally, system 300 may include one or more software components such as, for example, a computer-readable medium including computer-executable instructions for performing methods consistent with certain disclosed embodiments. It is contemplated that one or more of the hardware components listed above may be implemented using software. For example, storage 330 may include a software partition associated with one or more other hardware components of system 300. System 300 may include additional, fewer, and/or different components than those listed above. It is understood that the components listed above are exemplary only and not intended to be limiting.

Processor 305 may include one or more processors, each configured to execute instructions and process data to perform one or more functions associated with system 300. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated, processor 305 may be communicatively coupled to RAM 310, ROM 320, storage 330, database 340, I/O module 350, and interface module 360. Processor 305 may be configured to execute sequences of computer program instructions to perform various processes, which will be described in detail below. The computer program instructions may be loaded into RAM for execution by processor 305.

RAM 310 and ROM 320 may each include one or more devices for storing information associated with an operation of system 300 and/or processor 305. For example, ROM 320 may include a memory device configured to access and store information associated with system 300, including information for identifying, initializing, and monitoring the operation of one or more components and subsystems of system 300. RAM 310 may include a memory device for storing data associated with one or more operations of processor 305. For example, ROM 320 may load instructions into RAM 310 for execution by processor 305.

Storage 330 may include any type of storage device configured to store information that processor 305 may need to perform processes consistent with the disclosed embodiments.

Database 340 may include one or more software and/or hardware components that cooperate to store, organize, sort, filter, and/or arrange data used by system 300 and/or processor 305. For example, database 340 may include user-specific account information, predetermined menu/display options, and other user preferences. Alternatively, database 340 may store additional and/or different information. Database 340 may also contain a plurality of databases that are communicatively coupled to one another and/or processor 305.

I/O module 350 may include one or more components configured to communicate information with a user associated with system 300. For example, I/O module 350 may include a console with an integrated keyboard and mouse to allow a user to input parameters associated with system 300. I/O module 350 may also include a display including a GUI for outputting information on a monitor. I/O module 350 may also include peripheral devices such as, for example, a printer for printing information associated with system 300, a user-accessible disk drive (e.g., USB port, floppy, CD-ROM, DVD-ROM drive) to allow a user to input data stored on a portable media device, a microphone, a speaker system, or any other suitable type of interface device.

Interface 360 may include one or more components configured to transmit and receive data via a communication network, such as the Internet, a local area network, a workstation peer-to-peer network, a direct link network, a wireless network, or any other suitable communication platform. For example, interface 360 may include one or more modulators, demodulators, multiplexers, demultiplexers, network communication devices, wireless devices, antennas, modems, and any other type of device configured to enable data communication via a communication network.

In some examples, the system can include a central server for collecting and distributing digital content corresponding to a container. The server can include multiple servers, processors, and computing devices. In some examples, the server is a network of servers, some of which can be located remotely from one another. In another example, the server is a single server with multiple purposes. In yet another example, the server can be one or more servers dedicated to the operations described herein.

The server can host a web-based GUI in one example. The GUI can be accessed by a user via a user device. A user device can include any computing device, such as a cell phone, laptop, tablet, personal computer, workstation, or kiosk. The user device can include a non-transitory, computer-readable medium containing instructions that are executed by a processor. Example non-transitory, computer-readable mediums include RAM and ROM, disks, and other memory and storage that is accessible by a USB port, a floppy drive, CD-ROM, or DVD-ROM drive, and a flash drive, among others.

In some examples, the system can interface with other programs or applications. For example, the system can include an application programming interface (“API”) that is made available to external programs or applications. For example, the API can include a hook that allows a website to rank the importance of a user's contacts based on those contacts being assigned, or not assigned, to a container. In one example, a social-media site can access that API hook to gain ranking information regarding the user's contacts. The system can provide the user with a mechanism to turn functionality on and off as desired.

In one example, the system can make API calls to external systems, such as a social-media application. The example system can, for example, gather information from the social-media application regarding a user's friends lists, commonly contacted friends, shopping habits, hobbies, and interests. The system can use this information for any purpose, such as for suggesting contacts to be assigned to a container. In one example, the system can determine, via API calls to a social-media application, that the user frequently contacts both their mother and father through the social-media application. In that example, if the user assigns the mother as a contact associated with a container, the system can suggest that the user also assign the father as a contact associated with that container.

In another example, the system can make API calls to a social-media application to determine whether the user is contemplating a major decision such as buying or selling a house, moving, getting married or divorced, and so on. For example, the system can determine that the user is buying a house. In response, the system can prompt the user with suggestions for containers related to the house, such as a container that includes closing documents, appraisals, inspection reports, and any other relevant information. The system can suggest establishing a container that includes those documents, and could even suggest associating that container with the user's established real-estate agent, attorney, or accountant. These examples are merely illustrations of the functionality that the system can achieve. Other examples can be implemented as well.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for organizing and distributing digital information, comprising:
a storage device for storing digital information;
a user interface operatively connected to the storage device; and
a processor in communication with the storage device and the user interface, wherein the processor executes instructions contained on a non-transitory, computer-readable medium to perform steps including:
establishing a user-defined container corresponding to a portion of the digital information stored on the storage device;
establishing a user-defined trigger event for the container;
assigning a first contact to the container;
detecting the trigger event; and
providing, in response to detecting the trigger event, the first contact with access to the container.

2. The system of claim 1, wherein the processor adds a new content item to the established container based on user input.

3. The system of claim 1, wherein the first contact is provided access via at least one of sending the digital information to the first contact, providing a password for the first contact to download the digital information, and storing the digital information in a first-contact storage location.

4. The system of claim 1, wherein the processor establishes a plurality of user-defined containers.

5. The system of claim 1, wherein the trigger event is detected via entry of an authorized trigger key.

6. The system of claim 5, wherein the authorized trigger key is a password provided by an administrator of a user's estate.

7. The system of claim 1, wherein the trigger event is a target stock price.

8. The system of claim 1, wherein the trigger event is a date.

9. The system of claim 1, wherein the user interface comprises a contact list, and wherein assigning a first contact further comprises assigning one or more contacts of the contact list to a container.

10. The system of claim 1, wherein the trigger event causes the processor to provide the first contact full access to the user interface.

11. The system of claim 1, wherein the user interface comprises a timeline showing established user-defined trigger events.

12. A non-transitory, computer-readable storage medium including instructions that, when executed by a processor of a computing device, cause the processor to perform stages for organizing and distributing data, the stages comprising:
establishing a container based on a user's request;
associating data with the container;
assigning a first contact to the container;
establishing a user-defined trigger event for the container;
monitoring for the user-defined trigger event; and
in response to detecting the user-defined trigger event, providing the first contact with access to the container.

13. The non-transitory, computer-readable storage medium of claim 12, wherein the processor adds a new content item to the container based on user input.

14. The non-transitory, computer-readable storage medium of claim 12, wherein the first contact is provided access by sending the data associated with the container to the first contact.

15. The non-transitory, computer-readable storage medium of claim 12, wherein the first contact is provided access by providing a login to the first contact, by which the first contact can view or download the data associated with the container.

16. The non-transitory, computer-readable storage medium of claim 12, wherein detecting the user-defined trigger event comprises detecting entry of a passkey.

17. The non-transitory, computer-readable storage medium of claim 12, wherein the processor causes a representation of the container to be displayed on a user interface.

18. The non-transitory, computer-readable storage medium of claim 12, wherein the user-defined trigger event is a date.

19. The non-transitory, computer-readable storage medium of claim 19, wherein the processor causes a timeline to be displayed on a user interface, the timeline including the date.

20. The non-transitory, computer-readable storage medium of claim 12, wherein the user-defined trigger is a lack of response from the user within a predetermined time period.
